(19) United States
(12) Patent Application Publication
(10) Pub. No.: US 2008/0062497 A1
(43) Pub. Date: Mar. 13, 2008

(54) Optical Encoder Having Non-Collimated, Point-Source Light Emitter

(76) Inventors: Alan D. Bredon, Colleyville, TX (US); Troy Don Cook, Carrollton, TX (US); Robert Procsal, Richardson, TX (US)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 11/530,636

(22) Filed: Sep. 11, 2006

(51) Int. Cl. G02B 26/02

(52) U.S. Cl. 359/227; 359/841

(57) ABSTRACT

An optical encoder for producing adjustable quadrature phased signals by positioning of a light-controlling member includes a light emitter including a non-collimated, point-source light emitting diode for emitting light and a light receiver that receives light from the light emitter. A light-controlling member is disposed between the light emitter and the light receiver and includes a plurality of transparent portions for passing light from the light emitter and a plurality of non-transparent portions disposed alternately with the transparent portions for blocking light from the light emitter. The light emitter and the light-controlling member are moveable relative to each other.

### TECHNICAL FIELD OF THE INVENTION

The present invention relates to an optical encoder for detecting position and movement, such as, for example, rotational direction of a shaft, and more particularly to an optical encoder utilizing a non-collimated, point-source light emitter.

### BACKGROUND OF THE INVENTION

Previously designed optical encoders utilize a light emitting diode, lenses for collimating a light beam, a code wheel mounted on a shaft for modulating the light beam, and light detectors arranged in a particular way for receiving the modulated light and for converting the modulated light into electrical signals. Such designs have multiple sources of errors. The light beams emitted from the light emitting diode may not be identical and the code wheel and the phase plate may not be aligned. Code wheels have a tendency to warp and require specific slot spacing. Also, the distance between light detectors renders such encoder sensitive to gradients in the light beams. Most modern optical encoders utilize technology that requires that the code wheel or strip have a particular slot period and optical radius that is specific to a particular encoder light source and sensor pair and must be matched to the particular array of photo-detectors.

A need has thus arisen for an optical encoder having the ability to tolerate code wheels that are warped and code wheels or linear code strips that have distances between slots at any interval as well as code wheels that are not designed for a specific diameter, slot size and slot spacing. This requirement allows code wheels and strips of any desired resolution, number of apertures for a given distance, and various wheel diameters and materials, to be useable.

### SUMMARY OF THE INVENTION

In accordance with the present invention, an optical encoder is provided for producing adjustable quadrature phased signals by positioning of a light-controlling member. The encoder includes a light emitter including a non-collimated, point-source light emitting diode for emitting light. A light receiver receives light from the light emitter. A linear, circular, or other shaped light-controlling member is disposed between the light emitter and the light receiver and includes a plurality of transparent portions for passing light from the light emitter and a plurality of non-transparent portions disposed alternately with the transparent portions for blocking light from the light emitter. The light emitter and the light-controlling member are moveable relative to each other. The light-controlling member may be fabricated from various materials, such as, for example, metal with apertures, glass or plastic with printed, plated, or deposited opaque materials, or molded plastic with apertures.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a schematic diagram of the present optical encoder;

FIG. 2a and FIG. 2b are a front view of a light-controlling member for use with the present invention;

FIG. 3 is a front view of a light receiver for use with the present invention; and

FIG. 4 is a diagram of quadrature phasing of the output signals generated using the present invention.

### DESCRIPTION OF THE PREFERRED EMBODIMENTS

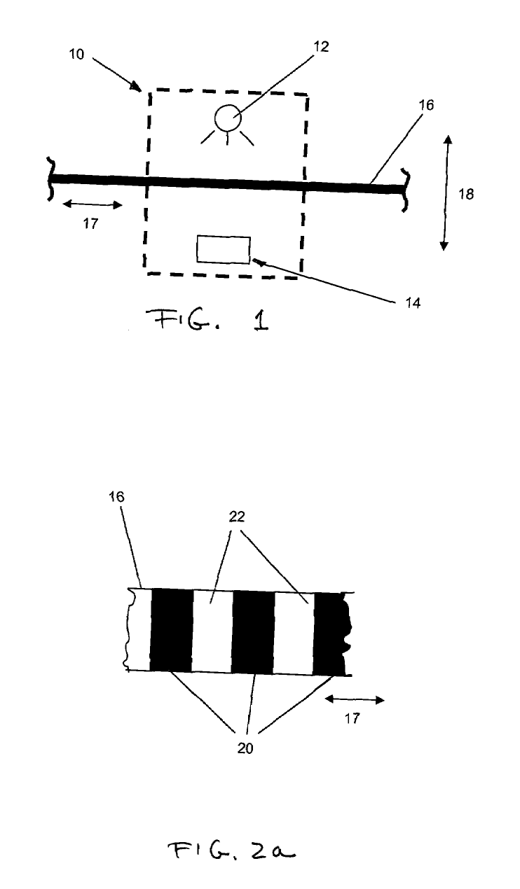

Referring simultaneously to FIGS. 1, 2, 3, and 4, the present optical encoder is illustrated, and is generally identified by the numeral 10. Optical encoder 10 includes a light emitter 12, a light receiver, generally identified by the numeral 14 and a light-controlling member 16 disposed between light emitter 12 and light receiver 14. Optical encoder 10 and light-controlling member 16 are moveable relative to each other in the longitudinal direction 17 and vertical direction 18.

An important aspect of the present invention is the use of a non-collimated, point source light emitting diode, such as the light emitter 12. Another important aspect is that the position of the light-controlling member 16 can be mounted at any vertical position in the vertical direction 18 relative to the light emitter 12 and the light detector 14.

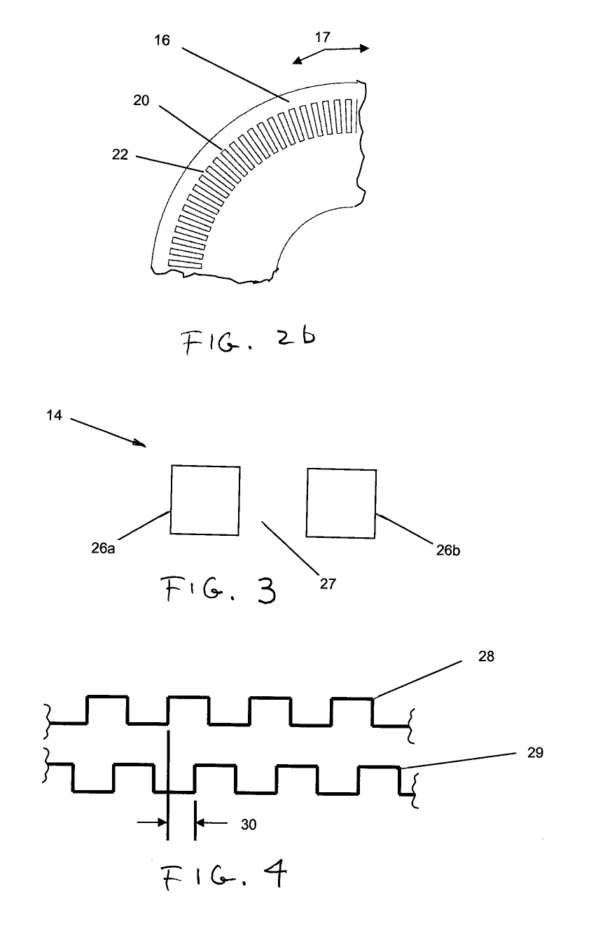

Light-controlling member 16 includes, for example, a ribbon-like resin film formed with a plurality of transparent portions 20 and non-transparent portions 22 alternating with each other. The transparent portions 20 and non-transparent portions 22 may have the same or a different width in the longitudinal direction 17 of the light-controlling member 16. Additionally, the width of the transparent portion 20 in the longitudinal direction 17 of the light-controlling member 16 and the width of the non-transparent portion 22 in the longitudinal direction 17 of the light-controlling member 16 may or may not be equal to each other. The light-controlling member 16 may be linear (FIG. 2a), circular, (FIG. 2b) or other shape and may be fabricated from various materials, such as, for example metal with apertures, glass or plastic with printed, plated, or deposited opaque materials, or molded plastic with apertures.

The light receiver 14 may include, for example, a pair of photodiodes 26a and 26b separated by a space 27. Photodiodes 26a and 26b are arranged adjacent to each other in the direction of the relative longitudinal movement between light emitter 12 and light-controlling member 16. Both photodiodes 26a and 26b may or may not have the same length and width, for example in the direction of the arrangement. The space 27 between the photodiodes 26a and 26b may or may not be equal to the width of the photodiodes 26a and 26b. The photodiodes 26a and 26b may or may not be incorporated on the same chip as the logic circuitry. The photodiodes 26a and 26b may or may not have apertures in place over them to further restrict the light striking them.

The outputs of photodiodes 26a and 26b are applied to additional circuitry (not shown) for determining speed and direction of, for example, shaft rotation on which the light-controlling member 16 is mounted. The quadrature output signals similar to those illustrated in FIG. 4, are produced by photodiodes 26a and 26b or are further processed by additional circuitry. The additional circuitry may or may not be included in the present embodiment of the optical encoder 10.

FIG. 4 illustrates the classic arrangement of signal output waveforms for two channels 28 and 29 of a quadrature encoder. These waveforms can be for example, sinusoidal, squarewave, or other shapes as determined by circuitry design. The direction of the relative motion in the longitudinal direction 17 of the light-controlling member 16 is determined by the difference in the phase angle 30 where channel A 28 either leads or lags channel B 29. The optimal phase angle 30 is usually, though not necessarily, 90°. An important aspect of the present invention is that the phase angle 30 is adjustable by changing the position of the light-controlling member 16 in the vertical direction 18 relative to the light-emitter 12 and light receiver 14.

Other alteration and modification of the invention will likewise become apparent to those of ordinary skill in the art upon reading the present disclosure, and it is intended that the scope of the invention disclosed herein be limited only by the broadest interpretation of the appended claims to which the inventor is legally entitled.

We claim:

1. An optical encoder for producing adjustable quadrature phased signals by positioning of a light-controlling member, comprising:
a light emitter including a non-collimated, point-source light emitting diode for emitting light;
a light receiver for receiving light from said light emitter;
a light-controlling member disposed between said light emitter and said light receiver, said light-controlling member including a plurality of transparent portions for passing light from said light emitter and a plurality of non-transparent portions disposed alternatively with said transparent portions for blocking light from said light emitter; and
said light emitter and said light-controlling member being moveable relative to each other.
